(19) United States
(12) Patent Application Publication
(10) Pub. No.: US 2026/0319428 A1
(43) Pub. Date: Oct. 15, 2026

(54) IMAGE FORMING APPARATUS

(71) Applicant: KYOCERA Document Solutions Inc., Osaka (JP)

(72) Inventor: Keisuke MIZUGUCHI, Osaka (JP)

(73) Assignee: KYOCERA Document Solutions Inc., Osaka (JP)

(21) Appl. No.: 19/637,849

(22) Filed: Apr. 2, 2026

(30) Foreign Application Priority Data
Apr. 14, 2025 (JP) 2025-066002

(51) Int. Cl. G03G 21/16; G03G 15/00

(52) U.S. Cl. CPC G03G 21/1638; G03G 15/6502; G03G 15/6552

(57) ABSTRACT

An image forming apparatus includes an apparatus main body, an opening/closing member, a first guide, a second guide, and a main conveying path. The apparatus main body includes a first conveying path. The opening/closing member forms a second conveying path with the apparatus main body. The first guide forms a third conveying path with the apparatus main body. The second guide merges the second and third conveying paths with the first conveying path. The main conveying path extends from the merging portion to a discharge port. The second guide is positioned with respect to the apparatus main body by turning the opening/closing member and the first guide to form the second conveying path and the third conveying path, and can be removed from the apparatus main body by turning the opening/closing member and the first guide to open the second conveying path and the third conveying path.

### INCORPORATION BY REFERENCE

This application is based on and claims the benefit of priority from Japanese patent application No. 2025-066002 filed on Apr. 14, 2025 which is incorporated by reference in its entirety.

### BACKGROUND

The present disclosure relates to an image forming apparatus including an opening/closing member which opens and closes a sheet conveying path.

In the image forming apparatus, a conveying path may be formed between the apparatus main body and an opening/closing member or a guide member turnably supported by the apparatus main body in order to treat a sheet jam caused in the conveying path. By opening the opening/closing member or the guide member, the conveying path is opened, and the jammed sheet can be easily removed.

For example, there may be a case where an inversion conveying path along which the inverted sheet is conveyed is formed between the apparatus main body and the opening/closing member, and a lower conveying path along which the sheet fed by the feeding device of the lower sheet feeding cassette is formed between the apparatus main body and the guide member. The inversion conveying path and the lower conveying path merge with the upper conveying path along which the sheet fed by the sheet feeding device of the uppermost sheet feeding cassette is conveyed.

In the image forming apparatus, the swing guide may be turnably connected to the jam treatment door (corresponding to the guide member). In this case, the swing guide forms a part of the vertical path (corresponding to the lower conveying path) and the horizontal path (corresponding to the inversion conveying path) when the jam treatment door is closed.

### SUMMARY

An image forming apparatus according to the present disclosure includes an apparatus main body, an opening/closing member, a first guide, a second guide, and a main conveying path. The apparatus main body is provided with a first conveying path along which a sheet is conveyed. The opening/closing member is turnably supported by the apparatus main body and forms a second conveying path along which the sheet is conveyed between the apparatus main body and the opening/closing member. The first guide is turnably supported by the apparatus main body inside the opening/closing member and forms a third conveying path along which the sheet is conveyed between the apparatus main body and the first guide. The second guide is detachably provided in the apparatus main body and merges the second conveying path and the third conveying path with the first conveying path. The main conveying path is provided in the apparatus main body and extends from a merging portion of the first, second, and third conveying paths to a sheet discharge port through an image forming part. The second guide is positioned with respect to the apparatus main body by turning the opening/closing member and the first guide to form the second conveying path and the third conveying path, and can be removed from the apparatus main body by turning the opening/closing member and the first guide to open the second conveying path and the third conveying path.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an internal structure of an image forming apparatus according to one embodiment of the present disclosure.

FIG. 2 is a front view showing the image forming apparatus according to the embodiment of the present disclosure, in which an inversion conveying path and a lower conveying path are formed by an outer cover, a first guide, and a second guide.

FIG. 3 is a front view showing the image forming apparatus according to the embodiment of the present disclosure, in which the outer cover and the first guide are turned downward and the second guide is removed.

FIG. 4 is a perspective view showing the first guide in the image forming apparatus according to the embodiment of the present disclosure.

FIG. 5 is a perspective view showing the second guide in the image forming apparatus according to the embodiment of the present disclosure.

FIG. 6 is a front view showing the image forming apparatus according to the embodiment of the present disclosure, in which the outer cover and the first guide are turned downward and the first guide is attached.

FIG. 7 is a cross-sectional view showing the image forming apparatus according to the embodiment of the present disclosure, in which the first guide and the second guide are positioned.

### DETAILED DESCRIPTION

Hereinafter, with reference to the attached drawings, an image forming apparatus according to one embodiment of the present disclosure will be described.

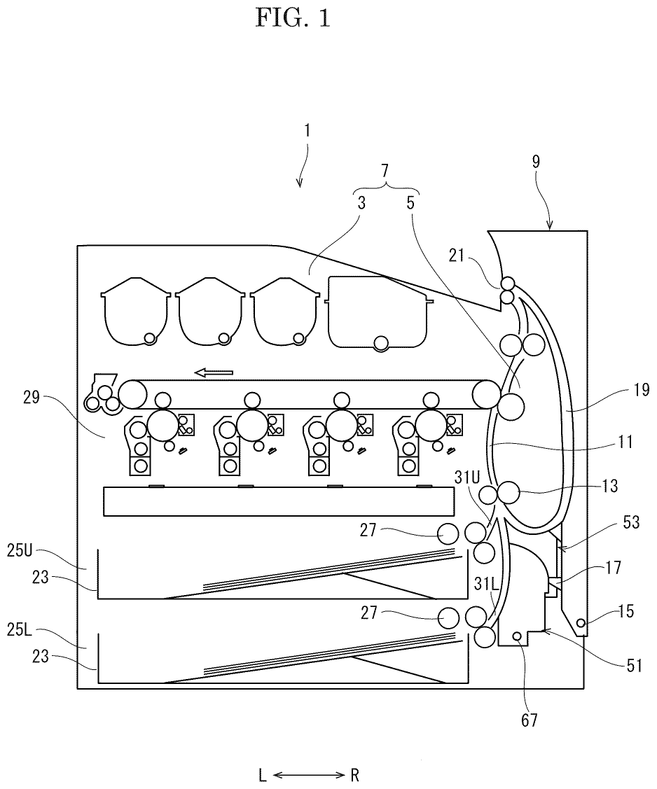

With reference to FIG. 1, the entire structure of the image forming apparatus 1 according to the embodiment will be described. FIG. 1 is a front view schematically showing the internal structure of the image forming apparatus 1. In each drawing, Fr, Rr, L, and R indicate the front side, the rear side, the left side, and the right side of the image forming apparatus 1, respectively.

The image forming apparatus 1 includes an apparatus main body 7 including a body unit 3 and a conveying unit 5, and an outer cover 9. The lower end of the conveying unit 5 is turnably supported by a turning shaft provided on the right side surface of the body unit 3. A main conveying path 11 along which a sheet is conveyed upwardly is formed between the body unit 3 and the conveying unit 5. A pair of registration rollers 13 is disposed at the upstream end of the main conveying path 11. One roller of the pair of registration rollers 13 is rotatably supported by the body unit 3, and the other roller is rotatably supported by the conveying unit 5.

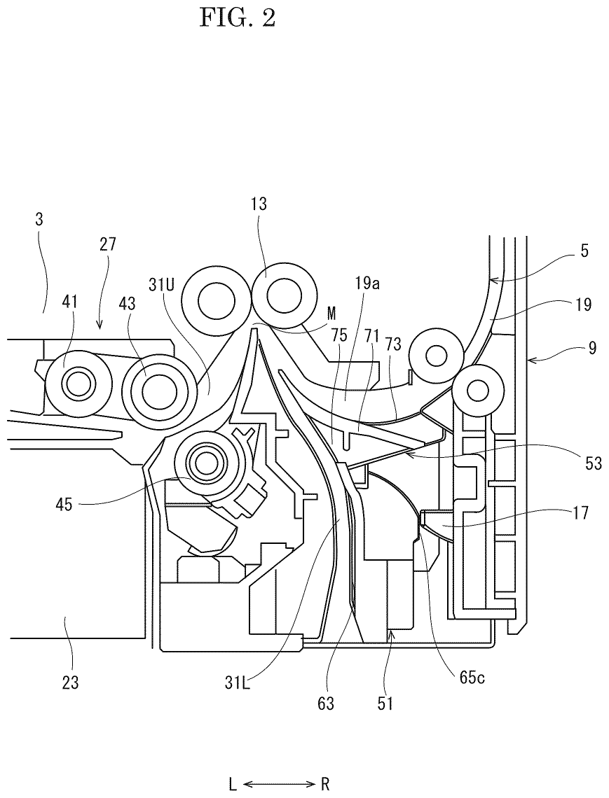

The outer cover 9 is disposed outside (on the right side) of the conveying unit 5. The lower end of the outer cover 9 is turnably supported by a turning shaft 15 provided on the right side surface of the body unit 3 outside and below the conveying unit 5. On the lower end portion of the inner surface of the outer cover 9, pressing projections 17 (see FIG. 2) projecting inward are formed at both the end portion in the width direction (the direction crossing the sheet conveying direction). The pressing projection 17 has a substantially triangular shape when viewed from the front side, and its top portion is notched in a straight line.

An inversion conveying path 19 along which the sheet is conveyed when the sheet is inversed is formed between the outer cover 9 and the conveying unit 5. A sheet discharge port 21 communicating with the main conveying path 11 is formed between the outer cover 9 and the body unit 3 above the conveying unit 5. The inversion conveying path 19 branches from the main conveying path 11 at a branch portion inside the discharge port 21 and extends below the conveying unit 5. The sheet is conveyed downward from the branch portion along the inversion conveying path 19.

In the lower portion in the body unit 3, upper and lower cassette housing spaces 25U and 25L (collectively referred to as the cassette housing space 25) which houses the sheet feeding cassettes 23 are provided. The front surface of the cassette housing space 25 is opened. The sheet feeding cassette 23 is detachably housed in the cassette housing space 25 through the opening. A sheet feeding device 27 which feeds the sheet from the sheet feeding cassette 23 is provided in the rear portion in the cassette housing space 25. The sheets fed by the upper and lower sheet feeding devices 27 are conveyed toward the main conveying path 11 through the upper and lower sheet feeding paths 31U and 31L.

Above the cassette housing spaces 25, an image forming part 29 is provided. The image forming part 29 forms an image on the sheet fed from the sheet feeding cassette 23 by the sheet feeding device 27 by an electrophotographic method. The sheet on which the image is formed by the image forming part 29 is conveyed along the main conveying path 11, and discharged through the discharge port 21.

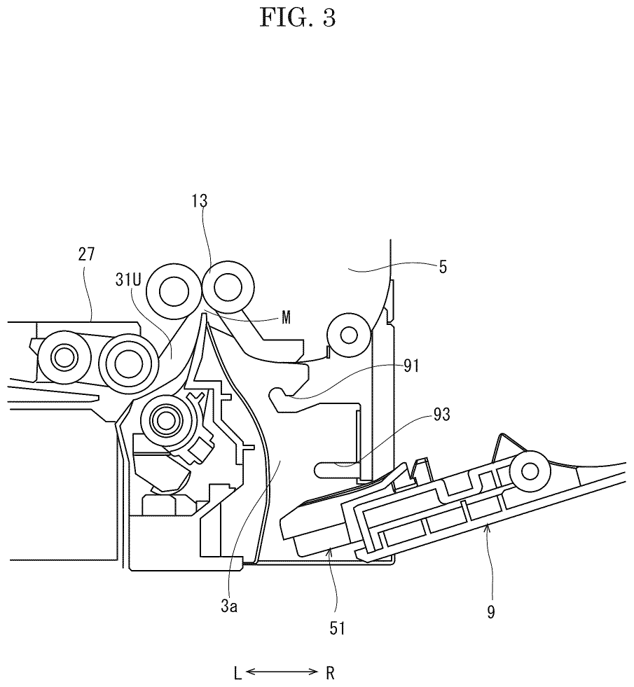

Next, with reference to FIG. 2 and FIG. 3, the upper and lower sheet feeding paths 31U and 31L along which the sheets fed by the upper and lower sheet feeding devices 27 are conveyed toward the main conveying path 11 will be described. FIG. 2 and FIG. 3 are front views showing the upper and lower sheet feeding paths 31U and 31L.

First, the sheet feeding device 27 will be briefly described. The sheet feeding device 27 includes a pickup roller 41, a sheet feeding roller 43 and a retard roller 45. The pickup roller 41 feeds the sheet by coming into contact with the uppermost sheet of the sheets stored in the sheet feeding cassette 23 and then rotating. The sheet feeding roller 43 comes into contact with the retard roller 45 to form a separation nip between both rollers. The sheet fed by the pickup roller 41 are separated one by one at the separation nip and then fed.

The upper sheet feeding path 31U is formed inside the body unit 3, and extends diagonally upward and rightward from the separation nip to the upstream portion of the pair of registration rollers 13. In the following description, the upstream portion of the pair of registration rollers (the lower part in the figure) is referred to as a merging portion M.

On the other hand, the lower sheet feeding path 31L is formed between the body unit 3, and a first guide 51 and a second guide 53, and extends from the separation nip (not shown in FIG. 2) to the merging portion M. The first guide 51 is arranged below the conveying unit 5 and inside the outer cover 9, and its lower end portion is turnably supported by the body unit 3. The second guide 53 is arranged above the first guide 51, below the conveying unit 5 and inside the outer cover 9, and is detachably supported by the body unit 3.

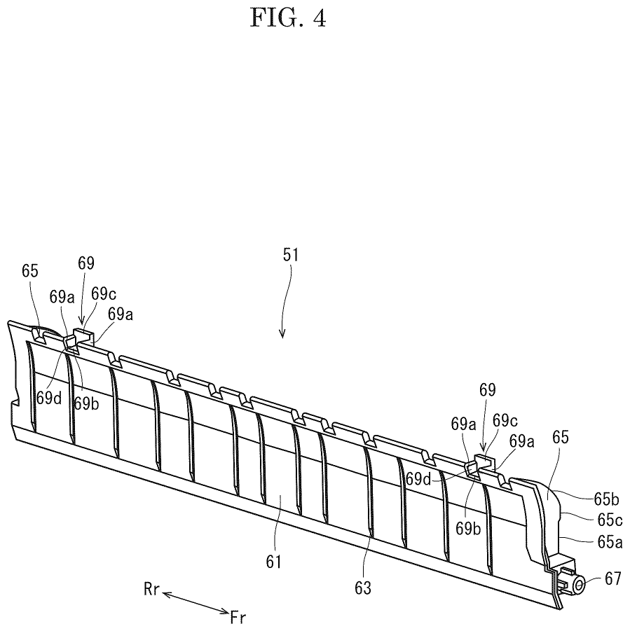

First, the first guide 51 will be described with reference to FIG. 4. FIG. 4 is a perspective view showing the first guide 51. The first guide 51 has a substantially rectangular plate-like guide plate 61 long in the width direction. A plurality of ribs 63 along the sheet conveying direction (the upper-and-lower direction) are formed on the inner (left) surface (surface facing the body unit 3) of the guide plate 61 at intervals in the width direction. On the outer (right) surface (surface facing the outer cover 9) of the guide plate 61, side plates 65 are provided along both side edges in the width direction. Each side plate 65 has a substantially semicircular shape when viewed from the front side, and the outer end edge of the side plate 65 has the lower portion 65a formed in a straight line and the upper portion 65b formed in an arc shape. The top portion 65c of the arc-shaped upper portion 65b is notched in a straight line. A turning shaft 67 is erected on the lower end portion of the outer surface of each side plate 65.

Further, on the upper end portion of the outer surface of the guide plate 61, engagement projections 69 are formed at both the end portions in the width direction. Each engagement projection 69 has side plate portions 69a facing in the width direction, and a bottom plate portion 69b and an end plate portion 69c provided between the side plate portions 69a. Between the side plate portions 69a, a groove 69d with open upper and left sides is formed along the conveying direction.

The first guide 51 is turnably supported by the body unit 3 by turnably connecting the turning shaft 67 to the body unit 3. When the first guide 51 is turned upward around the turning shaft 67, the upstream portion of the lower sheet feeding path 31L is formed between the first guide 51 and the body unit 3. When the first guide 51 is turned downward around the turning shaft 67, the upstream portion of the lower sheet feeding path 31L is opened.

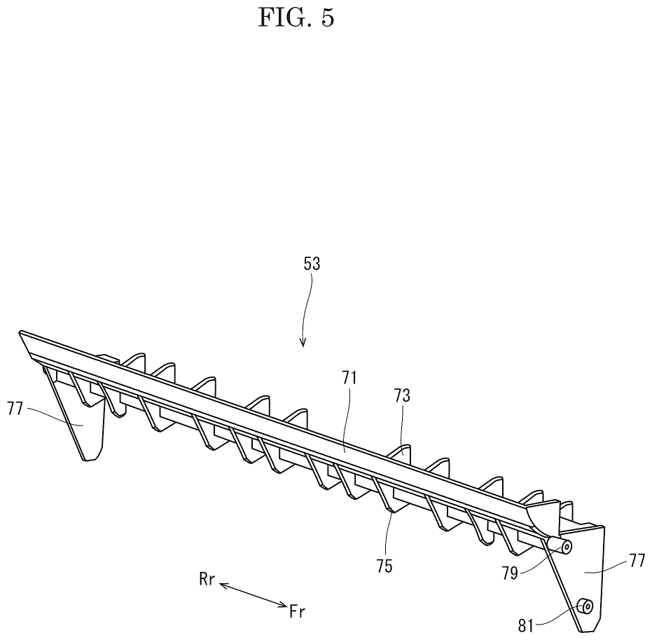

Next, the second guide 53 will be described with reference to FIG. 5. FIG. 5 is a perspective view showing the second guide 53. The second guide 53 has a substantially rectangular plate-like guide plate 71 long in the width direction. On the upper and lower surfaces of the guide plate 71, a plurality of upper ribs 73 and lower ribs 75 are formed at intervals in the width direction along the conveying direction. The upper and lower ribs 73 and 75 have a substantially triangular shape when viewed from the front side. As shown in FIG. 2, when viewed from the front side, the left side edge and the upper side edge of the second guide 53 are curved so as to converge at the tip of the guide plate 71.

At both the ends of the guide plate 71 in the width direction, side plates 77 are provided. Each side plate 77 is formed in a triangular shape when viewed from the front side. Upper and lower bosses 79 and 81 are erected on the upper left corner and the lower corner of the outer surface of each side plate 77.

The second guide 53 is detachably attached to the body unit 3. Specifically, as shown in FIG. 3, the front and rear side plates 3a of the body unit 3 have upper and lower notches 91 and 93 extending leftward from the right edge. The upper notch 91 is inclined slightly obliquely downward from the right edge, and then inclined upward at a substantially right angle. The lower notch 93 is formed substantially linearly from the right edge.

The second guide 53 is attached to the body unit 3 by inserting the upper and lower bosses 79 and 81 into the upper and lower notches 91 and 93 of the body unit 3. Thus, the downstream portion of the lower sheet feeding path 31L is formed between the second guide 53 and the body unit 3. The downstream portion of the lower sheet feeding path 31L is smoothly connected to the upstream portion formed between the first guide 51 and the body unit 3, and as shown in FIG. 2, the lower sheet feeding path 31L is formed which extends to the merging portion M while slightly curving leftward and upward.

Further, as shown in FIG. 2, between the second guide 53 and the body unit 3, a downstream inversion conveying path 19a, which continues to the inversion conveying path 19 formed between the outer cover 9 and the conveying unit 5, is formed. The downstream inversion conveying path 19a is curved downward from the inversion conveying path 19 toward the merging portion M. In this manner, the second guide 53 guides the upstream portion of the lower sheet feeding path 31L and the inversion conveying path 19 to the merging portion M.

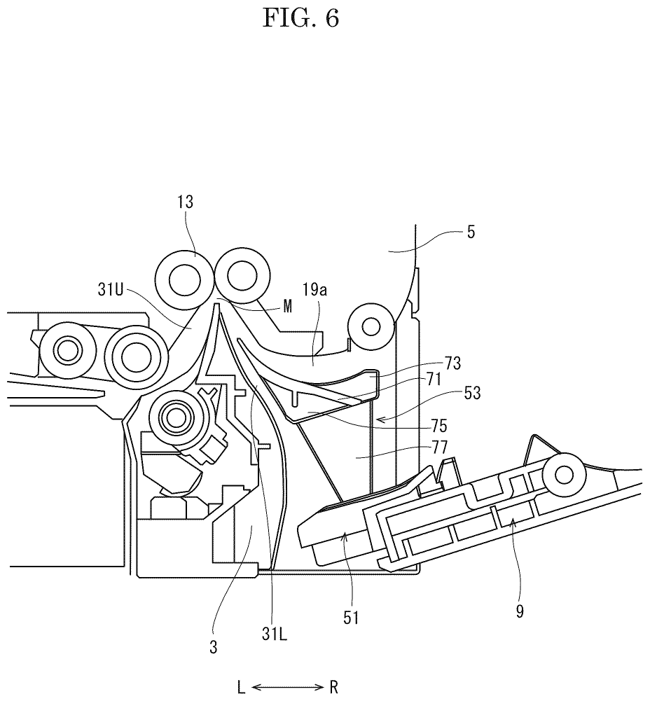

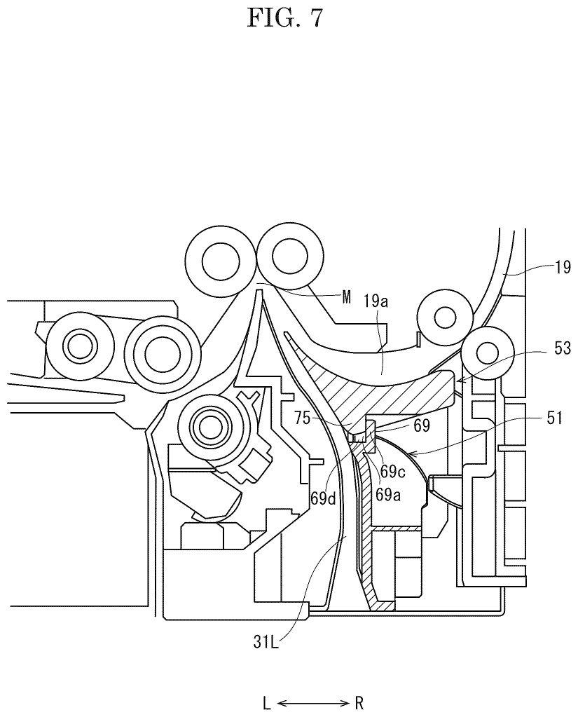

The forming and opening operations of the lower sheet feeding path 31L in the image forming apparatus 1 having the above configuration will be described with reference to FIG. 2, FIG. 3, FIG. 6 and FIG. 7. FIG. 6 and FIG. 7 are views showing the upper and lower sheet feeding paths 31U and 31L.

First, the operation of attaching the second guide 53 to the body unit 3 will be described. When the second guide 53 is attached, as shown in FIG. 3, the outer cover 9 and the first guide 51 are turned downward to expose the side plates 3a of the body unit 3. The first guide 51 and the outer cover 9 are turned until the upper and lower notches 91 and 93 are sufficiently exposed. The first guide 51 leans on the outer cover 9. The pressing projections 17 of the outer cover 9 abut on the curved upper portions 65b (see FIG. 4) of the end edges of the side plates 65 of the first guide 51.

Then, as described above, the upper and lower bosses 79 and 81 (see FIG. 5) of the second guide 53 are inserted into the upper and lower notches 91 and 93 of the body unit 3. Thus, as shown in FIG. 6, the second guide 53 is attached to the body unit 3, but at this stage, the second guide 53 is not accurately positioned with respect to the body unit 3.

Thereafter, the outer cover 9 is turned upward. Since the first guide 51 leans on the outer cover 9, when the outer cover 9 is turned upward, the first guide 51 is also turned upward by being pushed by the outer cover 9. More specifically, when the outer cover 9 is turned upward, the pressing projections 17 of the outer cover 9 push up the side plates 65 while lowering along the upper portions 65b of the end edges of the side plates 65 of the first guide 51. As shown in FIG. 2, when the outer cover 9 is turned until it is substantially upright, the pressing projections 17 of the outer cover 9 reaches the top portions 65c of the end edges of the side plates 65 of the first guide 51. More specifically, the top portions of the pressing projections 17 abut on the top portions 65c of the end edges of the side plates from the right side.

Further, as shown in FIG. 7, the engagement projections 69 of the first guide 51 engage with the lower ribs 75 of the second guide 53. More specifically, the lower rib 75 of the second guide 53 is inserted into the groove 69d of the engagement projection 69 of the first guide 51. Further, the end plate portion 69c of the engagement projection 69 abuts on the lower rib 75 of the second guide 53 from the right side. Since the first guide 51 is pushed in by the outer cover 9, the lower rib 75 of the second guide 53 is pushed in by the end plate portion 69c of the engagement projection 69. Thus, the second guide 53 is pushed leftward, the upper and lower bosses 79 and 81 are inserted to the innermost portions of the upper and lower notches 91 and 93, and the second guide 53 is positioned with respect to the body unit 3. Further, the turning of the first guide 51 is restricted. Further, since the lower rib 75 of the second guide 53 is held by the side plate portions 69a of the engagement projection 69 from both sides in the width direction, the relative movement of the first guide 51 and the second guide 53 along the width direction is restricted.

As a result, the lower sheet feeding path 31L is formed between the first guide 51 and the second guide 53, and the body unit 3. Further, between the outer cover 9 and the second guide 53, and the body unit 3, the inversion conveying paths 19 and 19a extending to the merging portion M are formed. As described above, the outer cover 9 is an example of the opening/closing member according to the present disclosure. The upper sheet feeding path 31U is an example of the first conveying path, the inversion conveying path 19 is an example of the second conveying path, and the lower sheet feeding path 31L is an example of the third conveying path.

After the lower sheet feeding path 31L and the inversion conveying path 19 are formed in this manner, the image forming operation is performed. The sheet fed from the upper sheet feeding cassette 23 by the sheet feeding device 27 is conveyed to the merging portion M along the upper sheet feeding path 31U, and after the conveying timing is adjusted by the pair of registration rollers 13, the sheet is conveyed to the main conveying path 11. Thereafter, an image is formed on the sheet in the image forming part 29. The sheet on which the image is formed is conveyed along the main conveying path 11, and then discharged through the discharge port 21. The sheet fed from the lower sheet feeding cassette 23 by the sheet feeding device 27 is conveyed to the merging portion M along the lower sheet feeding path 31L, and thereafter, after similarly forming an image, is discharged through the discharge port 21. During double-sided printing, the sheet on which the image is formed in the image forming part 29 is switched back at the discharge port 21 and then sent to the inversion conveying path 19. Thereafter, the sheet is conveyed to the merging portion M along the inversion conveying path 19, and thereafter, an image is similarly formed and then discharged through the discharge port 21.

When a sheet jam occurs in the inversion conveying path 19 during such an image forming operation, the outer cover 9 is turned downward. Since the inversion conveying path 19 is thereby opened, the jammed sheet can be easily removed. The center of gravity of the first guide 51 is located outside the turning shaft 67 in the upward turned state shown in FIG. 2. Therefore, when the outer cover 9 is turned downward, the first guide 51 is turned downward while leaning on the outer cover 9.

When a sheet jam occurs in the lower sheet feeding path 31L, the outer cover 9 is turned downward. At this time, the first guide 51 also turns downward as described above. As a result, a space is opened below the conveying unit 5. Thereafter, the second guide 53 is detached from the body unit 3 through this space. Specifically, the upper and lower bosses 79 and 81 are pulled out rightward along the upper and lower notches 91 and 93. Since the lower sheet feeding path 31L is opened substantially completely by removing the second guide 53 (see FIG. 3), the jammed sheet can be easily removed. After removing the sheet, the second guide 53 is attached to the body unit 3 as described above, and the outer cover 9 is turned upward.

As is apparent from the above description, according to the present disclosure, when a sheet jam generated in the lower sheet feeding path 31L is treated, the outer cover 9 is turned downward to turn the first guide 51 downward and the second guide 53 can be removed from the body unit 3. Therefore, since the lower sheet feeding path 31L can be opened over a wide range, the jammed sheet can be removed more easily.

The first guide 51 is turned with the turning of the outer cover 9. Therefore, the operation of turning only the first guide 51 becomes unnecessary, and the workability of sheet jam treatment can be improved.

Further, by turning the outer cover 9 upward to form the inversion conveying path 19, the first guide 51 and the second guide 53 can be accurately positioned with respect to the body unit 3, and the relative movement of the first guide 51 and the second guide 53 in the width direction is restricted.

Specifically, the first guide 51 is turned by turning the outer cover 9 until the inversion conveying path 19 is formed. When the first guide 51 is turned, the end plate portions 69c of the engagement projections 69 of the first guide 51 push the second guide 53. As a result, the second guide 53 is positioned and the first guide 51 is turned to a predetermined position. Further, since the lower ribs 75 of the second guide 53 are inserted into the grooves 69d of the engagement projections 69 of the first guide 51, the relative movement of the first guide 51 and the second guide 53 in the width direction is restricted. In this manner, the lower sheet feeding path 31L can be accurately formed.

Although the disclosure has been described with respect to certain embodiments, the disclosure is not limited to the foregoing embodiments. The above embodiments can be modified by those skilled in the art without departing from the scope and spirit of the disclosure.

### <Appendix 1>

An image forming apparatus according to Appendix 1 includes:
an apparatus main body provided with a first conveying path along which a sheet is conveyed;
an opening/closing member turnably supported by the apparatus main body and forming a second conveying path along which the sheet is conveyed between the apparatus main body and the opening/closing member;
a first guide turnably supported by the apparatus main body inside the opening/closing member and forming a third conveying path along which the sheet is conveyed between the apparatus main body and the first guide;
a second guide detachably provided in the apparatus main body and merging the second conveying path and the third conveying path with the first conveying path;
a main conveying path provided in the apparatus main body and extending from a merging portion of the first, second, and third conveying paths to a sheet discharge port through an image forming part, wherein
the second guide is positioned with respect to the apparatus main body by turning the opening/closing member and the first guide to form the second conveying path and the third conveying path, and can be removed from the apparatus main body by turning the opening/closing member and the first guide to open the second conveying path and the third conveying path.

### <Appendix 2>

The image forming apparatus according to Appendix 2 is the image forming apparatus according to Appendix 1, wherein
a center of gravity of the first guide is provided outside a rotational shaft of the first guide, and
the first guide leans on the opening/closing member.

### <Appendix 3>

The image forming apparatus according to Appendix 3 is the apparatus main body according to Appendix 1 or 2, wherein
the opening/closing member has a pressing projection projecting from an inner surface,
the first guide has an engagement projection projecting from an inner surface, and
when the opening/closing member is turned to form the second conveying path, the pressing projection presses the first guide to turn the first guide to form the third conveying path, and the engagement projection abuts on the second guide to position the second guide.

### <Appendix 4>

The image forming apparatus according to Appendix 4 is the image forming apparatus according to Appendix 3, wherein
the second guide has a rib along a sheet conveying direction,
the engagement projection has a groove along the conveying direction, and
when the first guide is turned to form the third conveying path, the engagement projection abuts on the rib of the second guide, and the rib is inserted into the groove.

### <Appendix 5>

The image forming apparatus according to Appendix 5 is the image forming apparatus according to any one of Appendixes 1 to 4, wherein
the second guide has a boss projecting in a width direction perpendicular to a sheet conveying direction,
the apparatus main body has a notch into which the boss can be inserted, and
the second guide is attached to the apparatus main body by inserting the boss into the notch.

### <Appendix 6>

The image forming apparatus according to Appendix 6 is the image forming apparatus according to any one of Appendixes 1 to 5, wherein
the first conveying path is formed between a sheet feeding device for feeding the sheet stored in a sheet feeding cassette and the merging portion,
the second conveying path is formed between a branch portion between the image forming part and the discharge port on the main conveying path, and the merging portion, and
the third conveying path is formed between a sheet feeding device of a lower sheet feeding cassette arranged below the sheet feeding cassette, and the merging portion.

What is claimed is:

1. An image forming apparatus comprising:
an apparatus main body provided with a first conveying path along which a sheet is conveyed;
an opening/closing member turnably supported by the apparatus main body and forming a second conveying path along which the sheet is conveyed between the apparatus main body and the opening/closing member;
a first guide turnably supported by the apparatus main body inside the opening/closing member and forming a third conveying path along which the sheet is conveyed between the apparatus main body and the first guide;
a second guide detachably provided in the apparatus main body and merging the second conveying path and the third conveying path with the first conveying path;
a main conveying path provided in the apparatus main body and extending from a merging portion of the first, second, and third conveying paths to a sheet discharge port through an image forming part, wherein
the second guide is positioned with respect to the apparatus main body by turning the opening/closing member and the first guide to form the second conveying path and the third conveying path, and can be removed from the apparatus main body by turning the opening/closing member and the first guide to open the second conveying path and the third conveying path.

2. The image forming apparatus according to claim 1, wherein
a center of gravity of the first guide is provided outside a rotational shaft of the first guide, and
the first guide leans on the opening/closing member.

3. The image forming apparatus according to claim 1, wherein
the opening/closing member has a pressing projection projecting from an inner surface,
the first guide has an engagement projection projecting from an inner surface, and
when the opening/closing member is turned to form the second conveying path, the pressing projection presses the first guide to turn the first guide to form the third conveying path, and the engagement projection abuts on the second guide to position the second guide.

4. The image forming apparatus according to claim 3, wherein
the second guide has a rib along a sheet conveying direction,
the engagement projection has a groove along the conveying direction, and
when the first guide is turned to form the third conveying path, the engagement projection abuts on the rib of the second guide, and the rib is inserted into the groove.

5. The image forming apparatus according to claim 1, wherein
the second guide has a boss projecting in a width direction perpendicular to a sheet conveying direction,
the apparatus main body has a notch into which the boss can be inserted, and
the second guide is attached to the apparatus main body by inserting the boss into the notch.

6. The image forming apparatus according to claim 1, wherein
the first conveying path is formed between a sheet feeding device for feeding the sheet stored in a sheet feeding cassette and the merging portion,
the second conveying path is formed between a branch portion between the image forming part and the discharge port on the main conveying path, and the merging portion, and
the third conveying path is formed between a sheet feeding device of a lower sheet feeding cassette arranged below the sheet feeding cassette, and the merging portion.
